(19) United States
(12) Patent Application Publication
(10) Pub. No.: US 2010/0108438 A1
(43) Pub. Date: May 6, 2010

(54) PANEL FOR ACOUSTIC DAMPING AND FIRE PROTECTION APPLICATIONS

(76) Inventor: William Christopher DUFFY, Thornhill (CA)

Correspondence Address: BENNETT JONES LLP, 3400 ONE FIRST CANADIAN PLACE, PO BOX 130, TORONTO, ON, M5X 1A4, CA

(21) Appl. No.: 12/263,862

(22) Filed: Nov. 3, 2008

(51) Int. Cl. E04B 1/88; E04B 1/82; B32B 37/00

(52) U.S. Cl. 181/290; 156/60

(57) ABSTRACT

An acoustic panel comprising an inner core sandwiched between outer sheets formed from a different material. According to an embodiment, the inner core comprises a cementicious material that also has fire resistant properties, and the outer sheets comprise metallic sheets. According to an embodiment, the outer sheets include metal tines for forming a bond between the respective metallic sheets and the inner core. The metal tines are formed as projections during the piercing of holes in the metallic sheets. According to an embodiment, the diameter of the holes and/or the thickness and/or composition of the cementicious material can be varied or configured to change the acoustic damping properties of the panel. According to another aspect, the panel comprises a fire resistant acoustic panel suitable for use as a fire protective or blast protection barrier.

### FIELD OF THE INVENTION

The present application relates to panels or barrier walls, and more particularly, to a panel with acoustic or damping properties, and suitable for fire resistant applications.

### BACKGROUND OF THE INVENTION

Residential, commercial, industrial workplaces and other facilities (such as hospitals, schools, government buildings) are all susceptible to a fire outbreak. For example, there are fire hazards associated with machinery. For example, there are fire hazards associated with equipment or facilities which house, use, or make flammable materials or fuels or other types of chemicals or hazardous materials.

Fire rated barriers are typically used to protect facilities and/or equipment against fire or the spread of fire. Fire rated barriers are designed to provide containment should a fire start, for example, as a result of equipment failure. In an electrical power grid, for example, transformers are a common piece of equipment in the distribution and transmission stations. Transformers are also prone to overheating resulting in fire and/or explosions, often without a prior warning. As a result, containment or isolation of fire hazardous equipment, such as transformers in a distribution and transmission station, is a critical safety and operational concern. Typically, this involves providing a fire barrier between two or more oil-filled transformers.

Industrial workplaces and facilities also have operating machinery which tends to generate noise levels which can be very loud at peak operating times. Similarly, commercial buildings, offices, facilities such as hospitals and clients, will have spaces or rooms that need to be isolated from noise. In order to reduce the noise levels, acoustic or sound damping structures can be put into place or the machines can be isolated in a separate area or room in the facility. It will be appreciated that while such known approaches can be effective in reducing noise levels, they require infrastructure for the facility.

Accordingly, there remains a need for improvements to address these shortcomings in the art.

### BRIEF SUMMARY OF THE INVENTION

The present invention comprises a panel or barrier wall that is tunable or configurable for acoustic damping. According to another embodiment, the present invention comprises a fire resistant panel that is configurable for absorbing sound waves.

According to an embodiment, the present invention provides an acoustic panel comprising: an inner core formed from a cementicious material; a first outer layer and a second outer layer; the inner core being positioned between the first outer layer and the second outer layer and being affixed to respective surfaces of the first and second outer layers; and at least one of the first outer layer and the second outer layer includes a plurality of perforations configured for allowing at least a portion of acoustic energy to pass into the inner core.

According to another embodiment, the present invention provides a method for making an acoustic panel, the method comprising the steps of: providing an inner core formed from a cementicious material which is partially cured; positioning an outer sheet on said partially cured inner core; the outer sheet including a plurality of holes and the plurality of holes including projections that are pushed into the partially cured inner core to form a mechanical bond between the outer sheet and the inner core.

According to another embodiment, the present invention provides a fire resistant acoustic panel assembly comprising: an inner core formed from a cementicious material; a first metallic layer and a second metallic layer; the inner core being positioned between the first metallic layer and the second metallic layer and being affixed to respective surfaces of the first and second metallic layers; and at least one of the first metallic layer and the second metallic layer including a plurality of perforations configured for allowing at least a portion of acoustic energy to pass into the inner core.

According to another embodiment, the present invention provides an acoustic panel assembly comprising: an acoustic panel; a support member configured for supporting the acoustic panel; the acoustic panel including, an inner core formed from a cementicious material; a first metallic layer and a second metallic layer; the inner core being positioned between the first metallic layer and the second metallic layer, and being affixed to respective surfaces of the first and the second metallic layers; at least one of the first metallic layer and the second metallic layer including a plurality of perforations configured for allowing at least a portion of acoustic energy to pass into the inner core; an acoustic absorptive material positioned in the support member and adjacent to the acoustic panel, and configured to provide additional absorption of acoustical energy.

According to another embodiment, the present invention comprises an acoustic panel comprising: an inner core formed from a fire resistant material; a first outer layer and a second outer layer; the inner core being positioned between the first outer layer and the second outer layer and being affixed to respective surfaces of the first and second outer layers; and at least one of the first outer layer and second outer layer including a plurality of perforations configured for allowing at least a portion of acoustic energy to pass into the inner core.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present application, and in which:

FIG. 1(a) is a front view of an acoustic panel according to an embodiment of the present invention;

FIG. 1(b) is a side view of the acoustic panel of FIG. 1 according to an embodiment of the present invention;

FIG. 2 is an exploded view of the acoustic panel of FIG. 1 according to an embodiment of the present invention;

FIG. 3(a) is a side sectional view of a mounting configuration for the acoustic panel;

FIG. 3(b) is a side sectional view of another mounting configuration for the acoustic panel;

FIG. 3(c) is a side sectional view of another mounting configuration for the acoustic panel; and

FIG. 4 is a side sectional view of an acoustic panel configurable for additional acoustic damping according to an embodiment of the invention.

Like reference numerals indicate like or corresponding elements in the drawings.

### DETAILED DESCRIPTION OF THE EMBODIMENTS

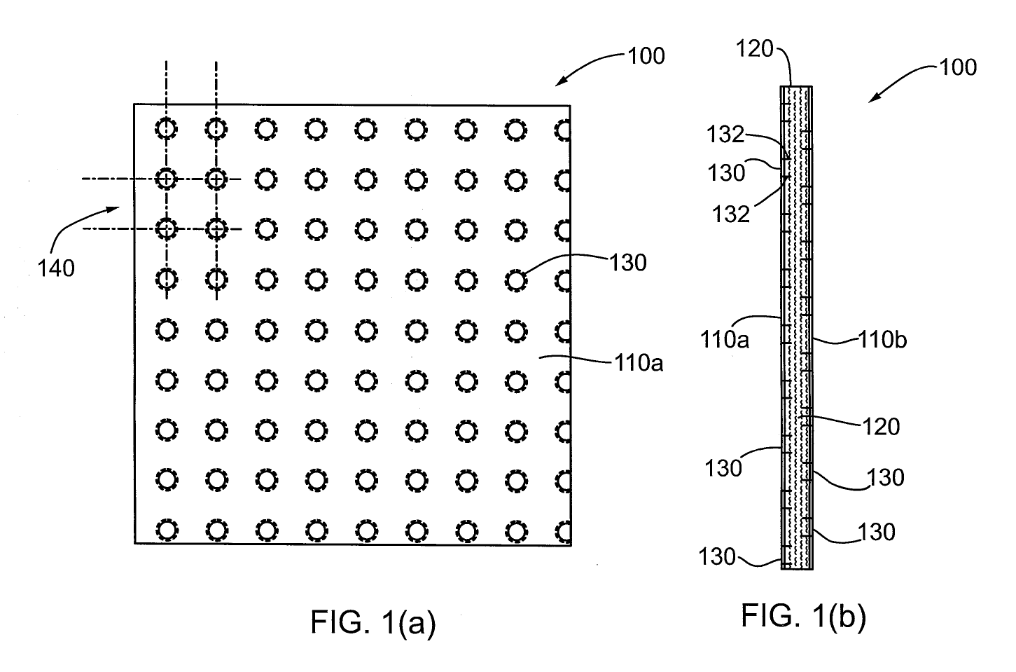

Reference is first made to FIGS. 1(a) and 1(b), which shows an acoustic panel according to an embodiment of the invention. The acoustic panel is indicated generally by reference 100 and comprises an outer panel, sheet or skin 110 and an inner core 120. A pair of outer panels, 110a and 110b, are affixed to each side of the inner core 120 and form a “sandwich” type structure. According to an embodiment, the acoustic panel 100 is configured to provide sound attenuation (i.e. absorption of sound waves) and also capable of functioning as a fire resistant barrier and/or providing impact or blast protection.

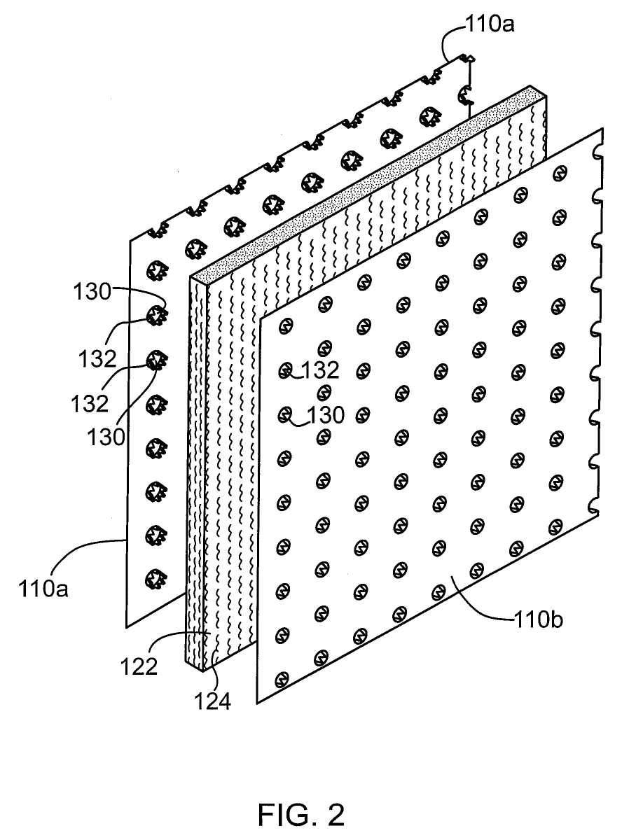

According to an embodiment, the inner core 120 a sound absorbing composite material. According to an embodiment, the outer panels 110 comprise metallic sheets that are mechanically bonded to both sides of the inner core 120. According to an embodiment, holes or openings 130 are pierced or punched in the metallic sheets 110. According to an embodiment, the pierced holes 130 are made in a grid pattern indicated generally by reference 140. The holes or openings 130 are pierced so as to include projection or tines 132 that remain attached to the metal sheet 110 as shown in FIG. 2. The metal tines or projections 132 form a structural element that is mechanically pressed into the material forming the inner core 120. The pierced holes or apertures 130 function to allow passage of sound waves into the inner core 120 where they are absorbed to provide sound dampening. The pierced holes or apertures 130 on the face of the outer panels 110 also provide a discontinuous surface which serves to break-up or interfere with the reflection of sound waves from the outer panels 110. According to an embodiment, by varying the diameter and/or number and/or spacing of the holes or apertures 130, the acoustic panel 100 can be tuned or configured for various sound damping characteristics or applications.

According to an embodiment, the acoustic panel 100 is made or assembled by placing one metallic sheet 110a against the inner core 120. The metallic sheet 110a includes the holes 130, which according to an embodiment, have been formed by piercing the metallic sheet 110a in known manner (for example, with punches and a press), and according to another aspect, the holes 130 are punched in a manner to form the tines 132 on one surface, i.e. the surface of the metallic sheet 110a that contacts the inner core 120. The metallic sheet 110a is positioned on the inner core 120 and pressure is applied to push the tines 132 into the inner core 120 before the composite material for the core has cured. This process is repeated for the other metallic sheet 110b. According to another aspect, the inner core 120 is placed between both of the metallic sheets 110a, 110b, e.g. to form a “sandwich” configuration and pressed together to drive the tines 132 into the inner core 130 before the composite core material has cured.

As will be described in more detail below, it has been discovered that the inner core 120 can be formed from certain materials that can comprise fire resistant compounds and can also be configured to provide acoustic dampening or sound absorption.

According to an embodiment, the inner core 120 comprises a composite material manufactured using the Hatschek process as will be understood by one skilled in the art. The composite core comprises a cement-limestone matrix 122 that is reinforced with cellulose and/or man-made fibers indicated generally by reference 124 as depicted in FIG. 2. The Hatschek process allows different types of reinforcing fibers to be blended and oriented within the cement-limestone matrix while also permitting the composite core to be manufactured in a variety of thicknesses.

According to one aspect, the thickness of the inner core 120 is varied to provide different degrees of acoustic dampening or sound absorption. According to another aspect, the acoustic dampening or sound absorption characteristics of the inner core 120 can be varied or “tuned” (e.g. maximum sound reduction in the desired octave bands) by adjusting the percentages of the individual components forming the composite material.

According to an exemplary implementation, the outer panels 110 are formed from metal sheets having a thickness of 24 gauge or 26 gauge. The pierced holes 130 have a nominal diameter of 7/32″ and the grid 140 comprises a nominal 25/32″× 25/32″ square grid arranged over substantially the entire surface of the metal sheet. With the 25/32″ centers on the grid 140, the diameter of the holes 130 can be increased (or decreased) and the diameter of the holes 130 can be used as another parameter for tuning the acoustic panel 100.

According to another aspect, the thickness of the metallic sheets for the outer panels 110 can be varied. For example, metallic sheets less than 24 ga or 26 ga can be used where the panel 100 is limited to acoustic loads, and thicker metallic sheets can be used where the panel 100 is subject to external loads, such as wind and/or blast forces or blast over pressures. According to another aspect, the outer panels 110 are fabricated from materials that are better able to withstand the intended environmental conditions. In a typical application, the metallic sheets would be formed of galvanized steel for cost considerations. In other applications, the metallic sheets are formed from more expensive materials, such as stainless steel, monel or other types of specialized metals, that are capable of withstanding the environmental conditions and/or application requirements, for example, chemical industry, or commercial building applications.

According to an embodiment, the inner core 120 is formed from a composite material comprising a primarily cement-limestone matrix (approximately >80%) indicated by reference 122 in FIG. 2. The primarily cement-limestone matrix 122 is reinforced with cellulose and/or man-made fibers indicated by reference 124 in FIG. 2. the fibers 124 are distributed throughout core 120. According to another embodiment, other or additional cementicious admixtures, for example, silica fume and/or fly ash, can be included in composite core material to enhance the mechanical and/or acoustic properties of the inner core 120. According to another aspect, the type, size and/or density of the fibers 124 can be varied to create, for example, a more flexible or lighter panel, or a more rigid or denser panel. According to another aspect, the thickness of the inner core 120 can be varied to increase or decrease the sound absorption properties of the panel 110 or for specific bandwidths.

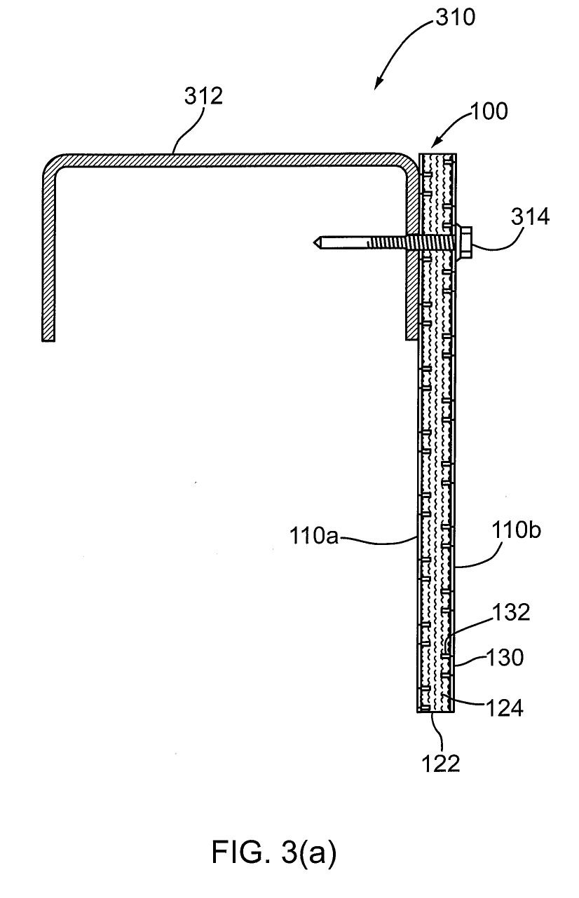

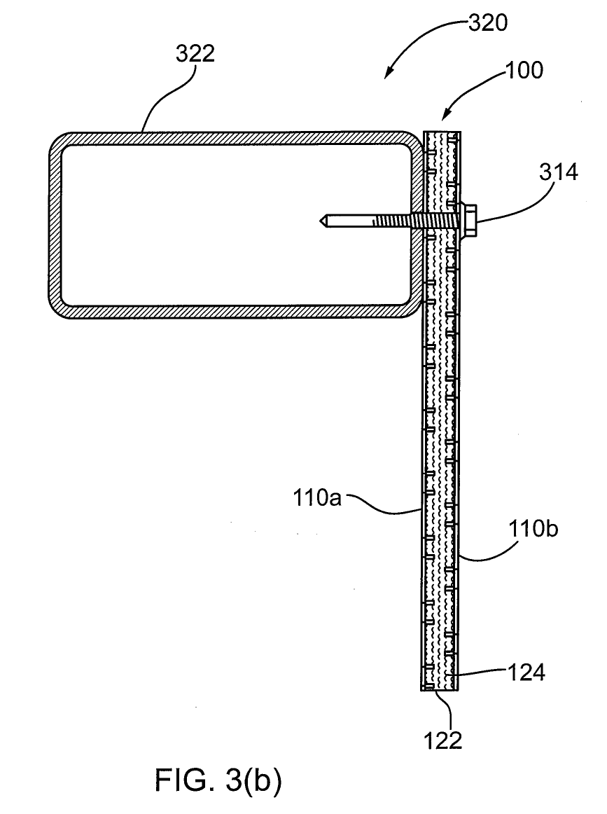

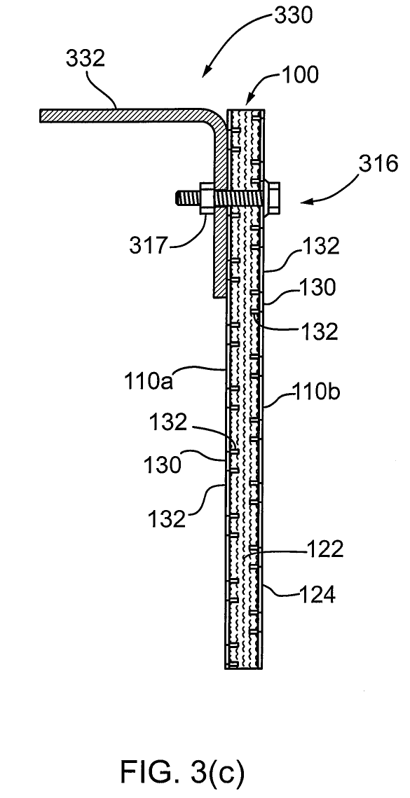

Reference is next made to FIG. 3(a), which shows different configurations for mounting or installing the acoustic panels 100 according to embodiments of the present invention. In a first configuration indicated generally by reference 310, the acoustic panel 100 is affixed or attached using suitable fasteners to a support framework comprising one or more C-channel members indicated by reference 312. As shown in FIG. 3, the acoustic panel 100 is attached to the C-channel member 312 with self-drilling screws 314. The type and size of fasteners used will depend on the size/weight of the acoustic panels 100 and/or the expected external loads exerted on the panel(s) 100. Similarly, the external design loads will affect or vary the spacing of the fasteners. For support members that have open or accessible sections, such as the C-channel member 312, nut and bolt fasteners can be used.

Reference is next made to FIG. 3(b) and a second configuration indicated generally by reference 320. The acoustic panel 100 is affixed or attached using suitable fasteners to a support framework comprising a hollow member (e.g. square or rectangular) indicated generally by reference 322. As depicted in FIG. 3(b), the fasteners comprise self-drilling screws 314. The size and number of self-drilling screws 314 used will depend on the factors as described above.

Reference is next made to FIG. 3(c), and a third configuration indicated by reference 330. The acoustic panel 100 is affixed or attached to an angle iron support member indicated by reference 332 using a bolt 316 and nut 317 for the fastener. As described above, the number and spacing of the bolts 316 (and nuts 317) will depend on the external design loads that the panel 100 is designed to withstand. In addition, if the panel 100 is configured with a thicker inner core 120 and/or thicker or heavier gauge outer sheets 110, then additional fasteners and/or structural support will be required to support the additional weight of the panel.

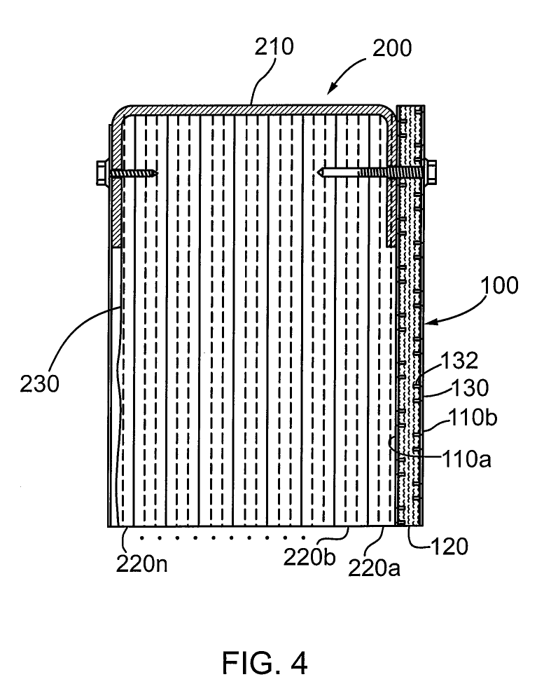

Reference is next made to FIG. 4, which shows an acoustic panel assembly according to another embodiment of the present invention and indicated generally by reference 200. The acoustic panel assembly 200 provides a configuration for use in applications where a larger acoustic assembly or acoustic performance is required, for example, a thicker inner core will provide increased sound dampening characteristics, but the weight considerations associated with a cementicious inner core 120 may be unsuitable for the application or installation. As shown, the acoustic panel assembly 200 comprises an acoustic panel 100, a support frame or member 210 and an absorptive material core 220. The acoustic panel 100 is configured in a manner as described above. The absorptive material core 220 comprises one or more layers of an acoustic absorptive mat indicated generally by reference 220, and individually by references 220a, 220b, . . . 220n. As shown, the absorptive mats or layers 220 are arranged to fill the cavity formed by the support frame 210.

According to another aspect, the acoustic panel assembly 200 can include a protective sheet or film indicated generally by reference 230 in FIG. 4. The protective film 230 covers the acoustic absorptive mats 220 and provides protection from dust, dirt, moisture and other environmental elements. According to another embodiment, the acoustic panel assembly 200 can include another metal sheet or panel indicated by reference 240. According to an embodiment, the metal sheet 240 comprises a metal sheet perforated with holes or apertures. According to one aspect, the metal sheet 240 serves to protect the protective film 230 and acoustic mats 220. In a manner similar to that described for the outer panels 110, the holes or apertures can have various opening sizes and/or hole centers for different acoustic configurations. The thickness of the metal sheet 240 can also be varied for different applications.

According to another embodiment, the acoustic panel assembly in accordance with the embodiments of the present invention is suitable to also function as a fire resistant panel. The fire resistance of the panel is derived from the fire resistive properties of the cementicious inner core 120. The fire resistance of the panel is further augmented by the metallic sheets utilized for the outer panels 110. By using different fire rated metals for the outer panels 110, the fire resistance of the panel assembly 100 can be increased or decreased as needed for the particular application or installation. Similarly, by varying the composition and/or thickness of the inner core 120, the fire resistance of the panel assembly 100 or 200 can be configured for the particular application or installation.

In summary and according to one aspect, the acoustic panel according to an embodiment of the present invention provides an acoustic panel that can be configured for sound dampening applications. According to another aspect, the acoustic panel can be tuned for specific sound dampening applications.

In summary and according to another embodiment of the present invention, the fire resistant acoustic panel provides a fire resistant panel that also functions as an acoustic barrier.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. An acoustic panel comprising:
an inner core formed from a cementicious material;
a first outer layer and a second outer layer;
said inner core being positioned between said first outer layer and said second outer layer and being affixed to respective surfaces of said first and second outer layers; and
at least one of said first outer layer and second outer layer including a plurality of perforations configured for allowing at least a portion of acoustic energy to pass into said inner core, wherein said first outer layer and said second outer layer comprise metallic sheets, and said plurality of perforations comprise hales pierced through said respective metallic sheets.

2. The acoustic panel as claimed in claim 1, wherein said cementicious material comprises a substantial cement-limestone composition.

3. The acoustic panel as claimed in claim 2, wherein said cement-limestone includes reinforcing fibers.

4. (canceled)

5. The acoustic panel as claimed in claim 1, wherein said pierced holes are formed with one or more tines, said one or more tines projecting into said inner core to form a mechanical bond between said inner core and said metallic sheets.

6. The acoustic panel as claimed in claim 1, wherein said perforations are fanned wit one or more predetermined sizes and said one or more sizes are configured to provide an acoustic dampening response.

7. The acoustic panel as claimed in claim 1, wherein said perforations are formed in a grid pattern, and said grid pattern is configured to provide an acoustic dampening response.

8. A method for forming an acoustic panel, said method comprising the steps of:
providing an inner core formed from a cementicious material tat is partially cured;
positioning a metallic outer sheet on said partially cured inner core;
said outer sheet including a plurality of holes and said holes having projections that are pushed into said partially cured inner core to form a mechanical bond between said outer sheet and said inner core.

9. The method as claimed in claim 8, further including a second outer sheet positioned against another surface of the said inner core and being affixed to said inner core.

10. The method as claimed in claim 8, wherein said holes are formed with one or more predetermined sizes and said one or more sizes are configured to provide an acoustic dampening response.

11. The method as claimed in claim 8, wherein said plurality of boles are arranged in a grid pattern and said grid pattern is configured to provide an acoustic dampening response.

12. A fire resistant acoustic panel comprising:
an inner core tuned from a cementicious material;
a first metallic layer and a second metallic layer;
said inner core being positioned between said first metallic layer and said second metallic layer and being affixed to respective surfaces of said first and second metallic layers; and
at least one of said first metallic layer and second metallic layer including a plurality of perforations configured for allowing at least a portion of acoustic energy to pass into said inner core, wherein said perforations comprise a plurality of pierced holes formed with one or more tines, said one or more tines projecting into said inner core to form a mechanical bond between said inner core and said metallic layers.

13. (canceled)

14. The fire resistant acoustic panel as claimed in claim 12, wherein said pierced holes are formed with one or more predetermined sizes and said one or more sizes are configured to provide an acoustic dampening response.

15. The fire resistant acoustic panel as claimed in claim 12, wherein said perforations are formed in a grid pattern, and said grid pattern is configured to provide an acoustic dampening response.

16. The fire resistant acoustic panel as claimed in claim 12, wherein said inner core has a thickness configured for providing an acoustic dampening response and a. fire resistance factor.

17. An acoustic panel assembly comprising:
an acoustic panel;
a support member configured for supporting said acoustic panel;
said acoustic panel including,
an inner core formed from a cementicious material;
a first metallic layer and a second metallic layer;
said inner core being positioned between said first metallic layer and said second metallic layer, and being affixed to respective surfaces of said first and second metallic layers;
at least one of said first metallic layer and second metallic layer including a plurality of perforations configured for allowing at least a portion of acoustic energy to pass into said inner core, wherein said perforations comprise a plurality of pierced holes formed with one or more tines, said one or more tines projecting into said inner core to form a mechanical bond between said inner core and said metallic layers;
an acoustic absorptive material positioned in said support member and adjacent to said acoustic panel, and configured to provide additional absorption of acoustical energy.

18. (canceled)

19. The acoustic panel assembly as claimed in claim 17, wherein said pierced hales are formed with one or more predetermined sizes and said one or more sizes are configured to provide an acoustic dampening response.

20. The acoustic panel as claimed in claim 17, further including a perforated metal sheet positioned against said acoustic absorptive material and opposite said acoustic panel.

21. An acoustic panel comprising:
an inner core formed from a fire resistant material;
a first outer layer and a second outer layer;
said inner core being positioned between said first outer layer and said second outer layer and being affixed to respective surfaces of said first and second outer layers; and
at least one of said first outer layer and second outer layer including a plurality of perforations configured for allowing at least a portion of acoustic energy to pass into said inner core, wherein said first outer layer and said second outer layer comprise metallic sheets, and said plurality of perforations comprise holes pierced through said respective metallic sheets.

22. The acoustic panel as claimed in claim 21, wherein said fire resistant material comprises a cementicious material.

23. (canceled)

24. The acoustic panel as claimed in claim 21, wherein said pierced holes are formed with one or more tines, said one or more tines projecting into said inner core to form a mechanical bond between said inner core and said metallic sheets.

25. The acoustic panel as claimed in claim 21, wherein said perforations are formed with one or more predetermined sizes and said one or more sizes are configured to provide an acoustic dampening response.

26. The acoustic panel as claimed in claim 21, wherein said perforations are formed in a grid pattern, and said grid pattern is configured to provide an acoustic dampening response.
